(19) United States
(12) Patent Application Publication
(10) Pub. No.: US 2009/0085838 A1
(43) Pub. Date: Apr. 2, 2009

(54) PLASMA DISPLAY DEVICE AND METHOD OF DRIVING PLASMA DISPLAY PANEL

(75) Inventors: Takahiko Origuchi, Osaka (JP); Hidehiko Shoji, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/282,943

(22) PCT Filed: Dec. 27, 2007
(86) PCT No.: PCT/JP2007/075091

§ 371 Date: Sep. 15, 2008

(30) Foreign Application Priority Data
Jan. 12, 2007 (JP) 2007-004154

(51) Int. Cl. G09G 3/28

(52) U.S. Cl. 345/60

(57) ABSTRACT

A plasma display device has a cumulative time measuring circuit for measuring the current-flow cumulative time, and a sustain electrode driving circuit. In the sustain electrode driving circuit, one field includes a plurality of subfields having an initializing period for initializing the discharge cells, an address period for selecting discharge cells to be discharged, and a sustain period for causing sustain discharge in the discharge cells selected in the address period. The sustain electrode driving circuit drives the sustain electrode by applying first voltage to the sustain electrode in the initializing period and applying second voltage to the sustain electrode in the address period. The sustain electrode driving circuit varies the value of the second voltage in response to the cumulative time measured by the cumulative time measuring circuit.

### TECHNICAL FIELD

The present invention relates to a plasma display device used in a wall-hanging television (TV) or a large monitor, and a driving method of a plasma display panel.

### BACKGROUND ART

A typical alternating-current surface discharge type panel used as a plasma display panel (hereinafter referred to as “panel”) has many discharge cells between a front plate and a back plate that are faced to each other. The front plate has the following elements:
a plurality of display electrode pairs disposed in parallel on a front glass substrate; and
a dielectric layer and a protective layer for covering the display electrode pairs.
   Here, each display electrode pair is formed of a pair of scan electrode and sustain electrode. The back plate has the following elements:
a plurality of data electrodes disposed in parallel on a back glass substrate;
a dielectric layer for covering the data electrodes;
a plurality of barrier ribs disposed on the dielectric layer in parallel with the data electrodes; and
phosphor layers disposed on the surface of the dielectric layer and on side surfaces of the barrier ribs.
   The front plate and back plate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color display.

A subfield method is generally used as a method of driving the panel. In this method, one field is divided into a plurality of subfields, and the subfields at which light is emitted are combined, thereby performing gradation display.

Each subfield has an initializing period, an address period, and a sustain period. In the initializing period, initializing discharge is caused, a wall charge required for a subsequent address operation is formed on each electrode, and a priming particle (an excitation particle as a detonating agent for discharge) for stably causing address discharge is generated. In the address period, address pulse voltage is selectively applied to a discharge cell where display is to be performed to cause address discharge, thereby forming a wall charge (hereinafter, this operation is referred to as “address”). In the sustain period, sustain pulse voltage is alternately applied to the display electrode pairs formed of the scan electrodes and the sustain electrodes, sustain discharge is caused in the discharge cell having performed address discharge, and a phosphor layer of the corresponding discharge cell is light-emitted, thereby displaying an image.

Of the subfield method, a new driving method is disclosed. In this driving method, the initializing discharge is performed using a gradually varying voltage waveform, and the initializing discharge is selectively applied to the discharge cell having performed sustain discharge. Thus, light emission that is not related to the gradation display is minimized, and the contrast ratio is improved.

In this driving method, for example, in the initializing period of one of a plurality of subfields, an initializing operation (hereinafter referred to as “all-cell initializing operation”) of causing initializing discharge in all discharge cells is performed. In the initializing period of the other subfields, an initializing operation (hereinafter referred to as “selection initializing operation”) of causing initializing discharge in only a discharge cell having performed sustain discharge is performed. Thanks to this driving manner, the light emission that is not related to the image display is determined only by light emission following the discharge of the all-cell initializing operation. As a result, the luminance in a black display region is provided only by feeble light emission by the all-cell initializing operation, and an image of high contrast can be displayed (e.g. patent document 1).

Patent document 1 also describes so-called narrow-width erasing discharge. In the narrow-width erasing discharge, the pulse width of the last sustain pulse in a sustain period is made shorter than the pulse widths of the other sustain pulses, and the potential difference between display electrode pairs due to the wall charge is reduced. By stably causing the narrow-width erasing discharge, a certain address operation is allowed in the address period in the subsequent subfield, and a plasma display device of high contrast can be achieved.

The definition and screen size of the panel have been recently increased, and hence the quality of the display image has been required to be further improved in the plasma display device. One of methods of improving the image display quality is to increase the luminance. It is effective to increase the partial pressure ratio of xenon in order to increase the light emission luminance, but increasing the partial pressure ratio increases the voltage required for addressing and destabilizes the addressing. In addition, the discharge characteristic of the panel varies according to the cumulative time (hereinafter referred to as “current-flow cumulative time”) when current is applied to the panel. When the current-flow cumulative time is increased, the address pulse voltage required for causing stable address discharge is also increased. Therefore, in order to stabilize the addressing, the address pulse voltage must be increased when the current-flow cumulative time is increased.

[Patent document 1] Japanese Patent Unexamined Publication No. 2000-242224

### SUMMARY OF THE INVENTION

The plasma display device of the present invention has the following elements:
a panel having a plurality of discharge cells including a display electrode pair that is formed of a scan electrode and a sustain electrode;
a cumulative time measuring circuit for measuring the cumulative time when current is applied to the panel; and
a sustain electrode driving circuit.
   where one field includes a plurality of subfields having the following time periods:
an initializing period for initializing the discharge cell;
an address period for selecting discharge cell to be discharged; and
a sustain period for causing sustain discharge in the discharge cell selected in the address period.
   The sustain electrode driving circuit drives the sustain electrode by applying first voltage to the sustain electrode in the initializing period and applying second voltage to the sustain electrode in the address period. The sustain electrode driving circuit varies the value of the second voltage in response to the cumulative time measured by the cumulative time measuring circuit.

Thus, even in a panel of high luminance, the value of the second voltage applied to the sustain electrode in the address period is varied in response to the cumulative time when current is applied to the panel. Therefore, when the current-flow cumulative time to the panel is increased, stable address discharge can be caused without increasing the address pulse voltage.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel.

FIG. 3 is a waveform chart of driving voltage applied to each electrode of the panel.

FIG. 4A is a waveform chart of driving voltage applied to a sustain electrode when the current-flow cumulative time of the panel measured by a cumulative time measuring circuit is a predetermined time or shorter in accordance with the first exemplary embodiment.

FIG. 4B is a waveform chart of driving voltage applied to a sustain electrode after the current-flow cumulative time of the panel measured by the cumulative time measuring circuit exceeds the predetermined time in accordance with the first exemplary embodiment.

FIG. 5 is a diagram showing an example of a relationship between the current-flow cumulative time of the panel and address pulse voltage Vd required for causing stable address discharge in accordance with the first exemplary embodiment.

FIG. 6 is a diagram showing an example of a relationship between voltage Ve2 and address pulse voltage Vd required for causing stable address discharge in accordance with the first exemplary embodiment.

FIG. 7 is a diagram showing an example of a relationship between the current-flow cumulative time of the panel and voltage Ve2 required for causing stable address discharge in accordance with the first exemplary embodiment.

FIG. 8 is a circuit block diagram of a plasma display device in accordance with the first exemplary embodiment.

FIG. 9 is a circuit diagram of a sustain pulse generating circuit in accordance with the first exemplary embodiment.

FIG. 10 is a timing chart illustrating an example of generation of voltage Ve1 and voltage Ve2 in accordance with the first exemplary embodiment.

FIG. 11 is a circuit diagram showing an example of a configuration where the value of voltage Ve2 is generated by switching in accordance with a second exemplary embodiment of the present invention.

FIG. 12A is a chart showing an example of a subfield configuration when the current-flow cumulative time is a predetermined time or shorter in accordance with the second exemplary embodiment.

FIG. 12B is a chart showing an example of a subfield configuration after the current-flow cumulative time exceeds the predetermined time in accordance with the second exemplary embodiment.

### REFERENCE MARKS IN THE DRAWINGS

1 plasma display device
10 panel
21 front plate
22 scan electrode
23 sustain electrode
24 display electrode pair
25, 33 dielectric layer
26 protective layer
31 back plate
32 data electrode
34 barrier rib
35 phosphor layer
41 image signal processing circuit
42 data electrode driving circuit
43 scan electrode driving circuit
44 sustain electrode driving circuit
45 timing generating circuit
48 cumulative time measuring circuit
50, 60 sustain pulse generating circuit
51, 61 electric power recovering circuit
52, 62 clamping circuit
81 timer
Q11, Q12, Q13, Q14, Q21, Q22, Q23, Q24, Q26, Q27, Q28, Q29, Q30 switching element
C10, C20, C30 capacitor
L10, L20 inductor
D11, D12, D21, D22, D30 diode
VE1, ΔVE, ΔVE2 power supply

### DETAILED DESCRIPTION OF PREFERRED EMBODIMENTS

Plasma display devices in accordance with exemplary embodiments of the present invention will be described hereinafter with reference to the accompanying drawings.

### First Exemplary Embodiment

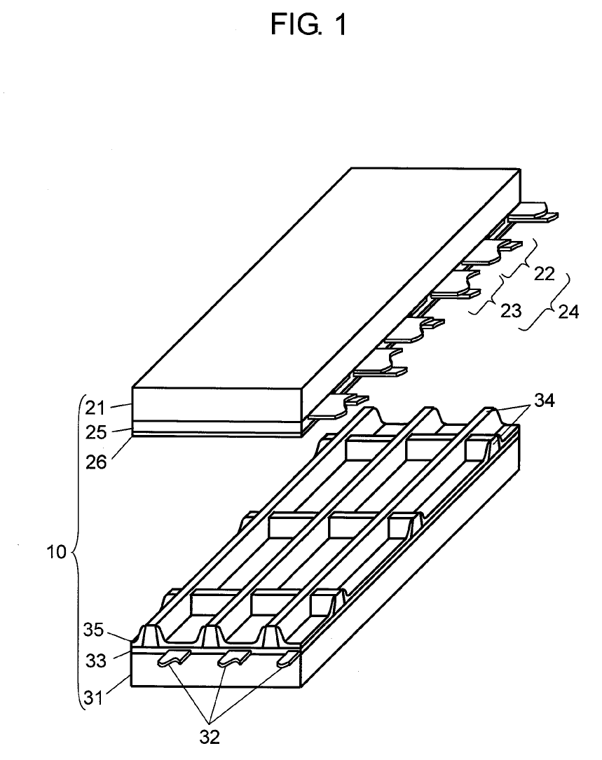

FIG. 1 is an exploded perspective view showing a structure of panel 10 in accordance with the first exemplary embodiment of the present invention. A plurality of display electrode pairs 24 formed of scan electrodes 22 and sustain electrodes 23 are disposed on glass-made front plate 21. Dielectric layer 25 is formed so as to cover scan electrodes 22 and sustain electrodes 23, and protective layer 26 is formed on dielectric layer 25.

Protective layer 26 is actually used as a material of the panel in order to reduce the discharge start voltage in a discharge cell. Protective layer 26 is made of material that is mainly made of MgO, and has a large secondary electron discharge coefficient and high durability when neon (Ne) and xenon (Xe) gases are filled.

A plurality of data electrodes 32 are formed on back plate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front plate 21 and back plate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon, for example, as discharge gas. In the present embodiment, discharge gas where xenon partial pressure is set at about 10% for luminance improvement is employed. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may be a structure having striped barrier ribs, for example. The mixing ratio of the discharge gas is not limited to the above-mentioned one, but may be another mixing ratio.

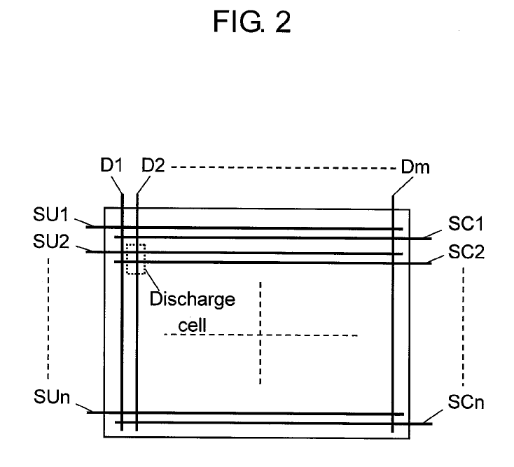

FIG. 2 is an electrode array diagram of panel 10 in accordance with the first exemplary embodiment of the present invention. In panel 10, n scan electrodes SC1 through SCn (scan electrodes 22 in FIG. 1) and n sustain electrodes SU1 through SUn (sustain electrodes 23 in FIG. 1) long in the column direction are arranged, and m data electrodes D1 through Dm (data electrodes 32 in FIG. 1) long in the row direction are arranged. Each discharge cell is formed in the intersecting part of a pair of scan electrode SCi (i=1 through n) and sustain electrode SUi and one data electrode Dj (j=1 through m), the number of formed discharge cells in the discharge space is m×n.

Next, a driving voltage waveform and its operation for driving panel 10 are described. The plasma display device of the present embodiment performs gradation display by a subfield method. In this method, one field is divided into a plurality of subfields, and emission and non-emission of light of each display cell are controlled in each subfield. Each subfield has an initializing period, an address period, and a sustain period.

In each subfield, in the initializing period, initializing discharge is performed to form a wall charge required for a subsequent address discharge on each electrode. The initializing operation has a function of reducing the discharge delay and generating a priming particle (an excitation particle as a detonating agent for discharge) for stably causing the address discharge. The initializing operation at this time includes an all-cell initializing operation of causing initializing discharge in all discharge cells, and a selection initializing operation of causing initializing discharge in a discharge cell that has performed sustain discharge in the previous subfield.

In the address period, address discharge is selectively caused in a discharge cell to emit light in a subsequent sustain period, thereby forming a wall charge. In the sustain period, as many sustain pulses as the number proportional to luminance weight are alternately applied to display electrode pairs 24, sustain discharge is caused in the discharge cell having caused address discharge, thereby emitting light. The proportionality constant is called “luminance magnification”.

In the present embodiment, one field is formed of 10 subfields (first SF, second SF, . . . , 10th SF), and respective subfields have luminance weights of 1, 2, 3, 6, 11, 18, 30, 44, 60 and 80, for example. The all-cell initializing operation is performed in the initializing period of the first SF, and the selection initializing operation is performed in the initializing period of each of the second SF through 10th SF. In the sustain period of each subfield, as many sustain pulses as the number derived by multiplying the luminance weight of each subfield by a predetermined luminance magnification are applied to respective display electrode pairs 24.

In the present embodiment, the number of subfields and luminance weight of each subfield are not limited to the above-mentioned values. The subfield configuration may be changed based on an image signal or the like.

In the present embodiment, for causing the address discharge, positive voltage is applied to sustain electrodes SU1 through SUn in the address period. The value of this voltage is controlled in response to the cumulative time when current is applied to panel 10. Here, the cumulative time is measured by the cumulative time measuring circuit (described later). Specifically, after the current-flow cumulative time of panel 10 exceeds a predetermined time, the value of the voltage applied to sustain electrodes SU1 through SUn in the address period in all subfields is made lower than that before the current-flow cumulative time exceeds the predetermined time. Thus, when the current-flow cumulative time is increased, stable address discharge is caused without increasing the address pulse voltage. The outline of the driving voltage waveform is firstly described, and the difference between the driving voltage waveform when the current-flow cumulative time measured by the cumulative time measuring circuit is the predetermined time or shorter and that after it exceeds the predetermined time is then described.

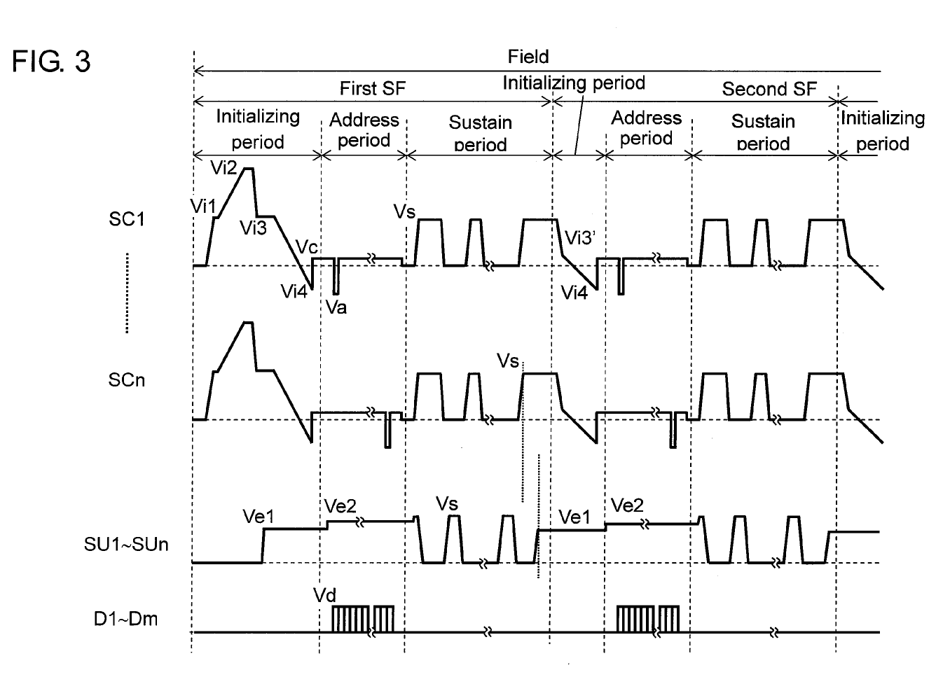

FIG. 3 is a waveform chart of driving voltage applied to each electrode of panel 10 in accordance with the first exemplary embodiment of the present invention. FIG. 3 shows driving voltage waveforms of two subfields, namely a subfield (hereinafter referred to as “all-cell initializing subfield”) for performing an all-cell initializing operation, and a subfield (hereinafter referred to as “selection initializing subfield”) for performing a selection initializing operation. However, a driving voltage waveform in another subfield is substantially similar to them.

First, a first SF as the all-cell initializing subfield is described.

In the first half of the initializing period of the first SF, 0 (V) is applied to data electrodes D1 through Dm and sustain electrodes SU1 through SUn, and a ramp waveform voltage (hereinafter referred to as “up-ramp waveform voltage”) is applied to scan electrodes SC1 through SCn. Here, the ramp waveform voltage gradually increases from voltage Vi1, which is not higher than a discharge start voltage, to voltage V12, which is higher than the discharge start voltage, with respect to sustain electrodes SU1 through SUn.

While the up-ramp waveform voltage increases, feeble initializing discharge continuously occurs between scan electrodes SC1 through SCn and sustain electrodes SU1 through SUn, and feeble initializing discharge continuously occurs between scan electrodes SC1 through SCn and data electrodes D1 through Dm. Negative wall voltage is accumulated on scan electrodes SC1 through SCn, and positive wall voltage is accumulated on data electrodes D1 through Dm and sustain electrodes SU1 through SUn. Here, the wall voltage on the electrodes means the voltage generated by the wall charges accumulated on the dielectric layer covering the electrodes, the protective layer, and the phosphor layer.

In the last half of the initializing period, positive voltage Ve1 as a first voltage is applied to sustain electrodes SU1 through SUn, and 0 (V) is applied to data electrodes D1 through Dm. A ramp waveform voltage (hereinafter referred to as “down-ramp waveform voltage”) is applied to scan electrodes SC1 through SCn. Here, the ramp waveform voltage gradually decreases from voltage V13, which is not higher than the discharge start voltage, to voltage V14, which is higher than the discharge start voltage, with respect to sustain electrodes SU1 through SUn. While the ramp waveform voltage decreases, feeble initializing discharge continuously occurs between scan electrodes SC1 through SCn and sustain electrodes SU1 through SUn, and feeble initializing discharge continuously occurs between scan electrodes SC1 through SCn and data electrodes D1 through Dm. The negative wall voltage on scan electrodes SC1 through SCn and the positive wall voltage on sustain electrodes SU1 through SUn are reduced, positive wall voltage on data electrodes D1 through Dm is adjusted to a value suitable for the address operation. Thus, the all-cell initializing operation of applying initializing discharge to all discharge cells is completed.

In the subsequent address period, positive voltage Ve2 as a second voltage is applied to sustain electrodes SU1 through SUn, and voltage Vc is applied to scan electrodes SC1 through SCn.

Negative scan pulse voltage Va is applied to scan electrode SC1 in the first column, positive address pulse voltage Vd is applied to data electrode Dk (k is 1 through m), of data electrodes D1 through Dm, in the discharge cell to emit light in the first column. The voltage difference in the intersecting part of data electrode Dk and scan electrode SC1 is derived by adding the difference between the wall voltage on data electrode Dk and that on scan electrode SC1 to the difference (Vd−Va) of the external applied voltage, and exceeds the discharge start voltage. Discharge occurs between data electrode Dk and scan electrode SC1. Positive voltage Ve2 is applied to sustain electrodes SU1 through SUn, so that the voltage difference between sustain electrode SU1 and scan electrode SC1 is derived by adding the difference between the wall voltage on sustain electrodes SU1 and that on scan electrode SC1 to the difference (Ve2−Va) of the external applied voltage. At this time, by setting voltage Ve2 at a value slightly lower than the discharge start voltage, the state can be generated where discharge does not actually occur but is apt to occur between sustain electrodes SU1 and scan electrode SC1. Thus, discharge occurring between data electrode Dk and scan electrode SC1 can cause discharge between sustain electrode SU1 and scan electrode SC1 in the region crossing data electrode Dk. Thus, the address discharge occurs in the discharge cell to emit light, positive wall voltage is accumulated on scan electrode SC1, negative wall voltage is accumulated on sustain electrode SU1, and negative wall voltage is accumulated on data electrode Dk.

Thus, an address operation of causing address discharge in the discharge cell to emit light in the first column and accumulating wall voltage on each electrode is performed. The voltage in the intersecting parts of scan electrode SC1 and data electrodes D1 through Dm to which address pulse voltage Vd is not applied does not exceed the discharge start voltage, so that address discharge does not occur. This address operation is repeated until it reaches the discharge cell in the n-th column, and the address operation is completed.

In the present embodiment, the value of positive voltage Ve2 is switched between two different values to drive panel 10 (not shown in FIG. 3). The lower voltage value is referred to as “Ve2L”, and the higher voltage value is referred to as “Ve2H”. In the present embodiment, Ve2L is a voltage value equal to above-mentioned positive voltage Ve1, and Ve2H is a voltage value derived by adding positive voltage ΔVe to positive voltage Ve1.

Before the current-flow cumulative time of panel 10 measured by the cumulative time measuring circuit (described later) exceeds the predetermined time, voltage Ve2 is set at Ve2H in the address period in all subfields, thereby performing addressing. After the current-flow cumulative time of panel 10 exceeds the predetermined time, voltage Ve2 is set at Ve2L in the address period in all subfields, thereby performing addressing. This configuration is described later in detail. Thus, when the current-flow cumulative time is increased, stable address discharge is caused without increasing address pulse voltage Vd.

In the subsequent sustain period, positive sustain pulse voltage Vs is firstly applied to scan electrodes SC1 through SCn, and 0 (V) is applied to sustain electrodes SU1 through SUn. In the discharge cell having caused the address discharge, the voltage difference between scan electrode SC1 and sustain electrode SUi is obtained by adding the difference between the wall voltage on scan electrode SCi and that on sustain electrode SUi to sustain pulse voltage Vs, and exceeds the discharge start voltage.

Sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell where address discharge has not occurred in the address period, sustain discharge does not occur and the wall voltage at the completion of the initializing period is kept.

Subsequently, 0 (V) is applied to scan electrodes SC1 through SCn, and sustain pulse voltage Vs is applied to sustain electrodes SU1 through SUn. In the discharge cell having caused the sustain discharge, the voltage difference between sustain electrode SUi and scan electrode SCi exceeds the discharge start voltage. Therefore, sustain discharge occurs between sustain electrode SUi and scan electrode SCi again, negative wall voltage is accumulated on sustain electrode SUi, and positive wall voltage is accumulated on scan electrode SCi. Hereinafter, similarly, as many sustain pulses as the number derived by multiplying the luminance weight by luminance magnification are alternately applied to scan electrodes SC1 through SCn and sustain electrodes SU1 through SUn to cause potential difference between the electrodes of display electrode pairs 24, thereby continuing sustain discharge in the discharge cell that has caused the address discharge in the address period.

At the end of the sustain period, voltage difference of a so-called narrow-width pulse shape is applied between scan electrodes SC1 through SCn and sustain electrodes SU1 through SUn, and the wall voltage on scan electrode SCi and sustain electrode SUi is eliminated while the positive wall voltage is left on data electrode Dk. The sustain operation in the sustain period is completed. Hereinafter, this discharge is referred to as “erasing discharge”.

After a predetermined time interval after applying voltage Vs for generating the last sustain discharge, namely erasing discharge, to scan electrodes SC1 through SCn, voltage Ve1 for reducing the potential difference between the electrodes of display electrode pair 24 is applied to sustain electrodes SU1 through SUn. Thus, the sustain operation in the sustain period is completed.

Next, the operation of a second SF, namely the selection initializing subfield, is described hereinafter.

In the selection initializing period of the second SF, while voltage Ve 1 is applied to sustain electrodes SU1 through SUn and 0 (V) is applied to data electrodes D1 through Dm, a down-ramp waveform voltage gradually decreasing from voltage V13′ to voltage V14 is applied to scan electrodes SC1 through SCn.

In the discharge cell that has caused the sustain discharge in the sustain period of the previous subfield, feeble initializing discharge occurs, and the wall voltage on scan electrode SCi and sustain electrode SUi is reduced. Regarding data electrode Dk, sufficient positive wall voltage is accumulated on data electrode Dk by the next previous sustain discharge, so that the excessive part of the wall voltage is discharged to adjust the wall voltage to be appropriate for the address operation.

While, in the discharge cell that has not caused the sustain discharge in the previous subfield, discharge is not performed and the wall charge at the completion of the initializing period of the previous subfield is kept. In the selection initializing operation, initializing discharge is selectively performed in the discharge cell where a sustain operation is performed in the sustain period of the next previous subfield.

The operation of the subsequent address period is similar to the operation of the address period of the all-cell initializing subfield, and hence is not described. The operation of the subsequent sustain period is similar except for the number of sustain pulses. In the third SF through 10th SF, the operation of the initializing period is a selection initializing operation similar to that of the second SF, the address operation in the address period is also similar to that of the second SF, and the operation of the sustain period is similar except for the number of sustain pulses.

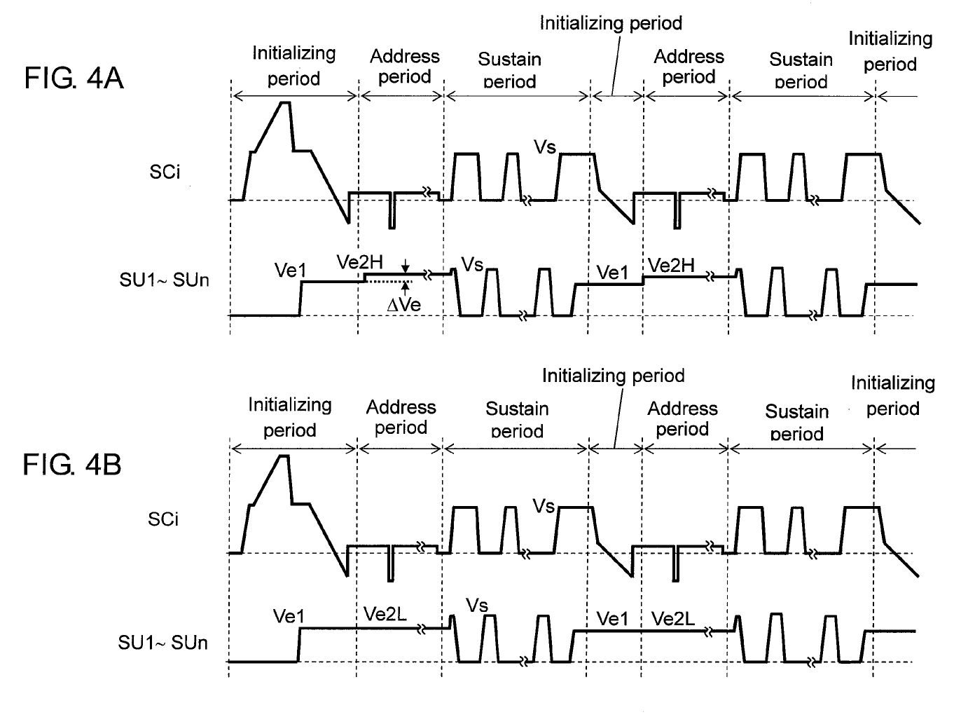

Next, the difference between the driving voltage waveform when the current-flow cumulative time measured by the cumulative time measuring circuit is a predetermined time or shorter and the driving voltage waveform after it exceeds the predetermined time is described with reference to FIG. 4.

FIG. 4 is a waveform chart of driving voltage applied to sustain electrodes SU1 through SUn in accordance with the first exemplary embodiment. FIG. 4A is a waveform chart when the current-flow cumulative time of panel 10 measured by the cumulative time measuring circuit is the predetermined time or shorter (500 hours or shorter in the present embodiment). FIG. 4B is a waveform chart after the current-flow cumulative time exceeds the predetermined time (longer than 500 hours in the present embodiment).

In the present embodiment, as discussed above, the value of positive voltage Ve2 applied to sustain electrodes SU1 through SUn in the address period is switched between two different values according to whether or not the current-flow cumulative time of panel 10 measured by the cumulative time measuring circuit (described later) is the predetermined time or shorter. Here, the two different values are higher voltage value Ve2H and lower voltage value Ve2L.

Specifically, when it is determined that the current-flow cumulative time of panel 10 measured by the cumulative time measuring circuit is the predetermined time or shorter (500 hours or shorter in the present embodiment), voltage Ve2 is set at Ve2H, and addressing is performed in the address period of all subfields, as shown in FIG. 4A.

When it is determined that the current-flow cumulative time of panel 10 measured by the cumulative time measuring circuit exceeds 500 hours, voltage Ve2 is set at Ve2L, and addressing is performed in the address period of all subfields, as shown in FIG. 4B. In the present embodiment, such a configuration achieves stable address discharge. A reason for this is as follows.

The discharge characteristic varies dependently on the current-flow cumulative time of panel 10, and an element for destabilizing the discharge also varies dependently on the current-flow cumulative time of panel 10. This element, for example, is discharge delay (time delay since voltage for causing the discharge is applied to the discharge cell until the discharge is caused actually) or dark current (current occurring in the discharge cell regardless of the discharge). Therefore, the applied voltage required for causing stable address discharge varies dependently on the current-flow cumulative time of panel 10.

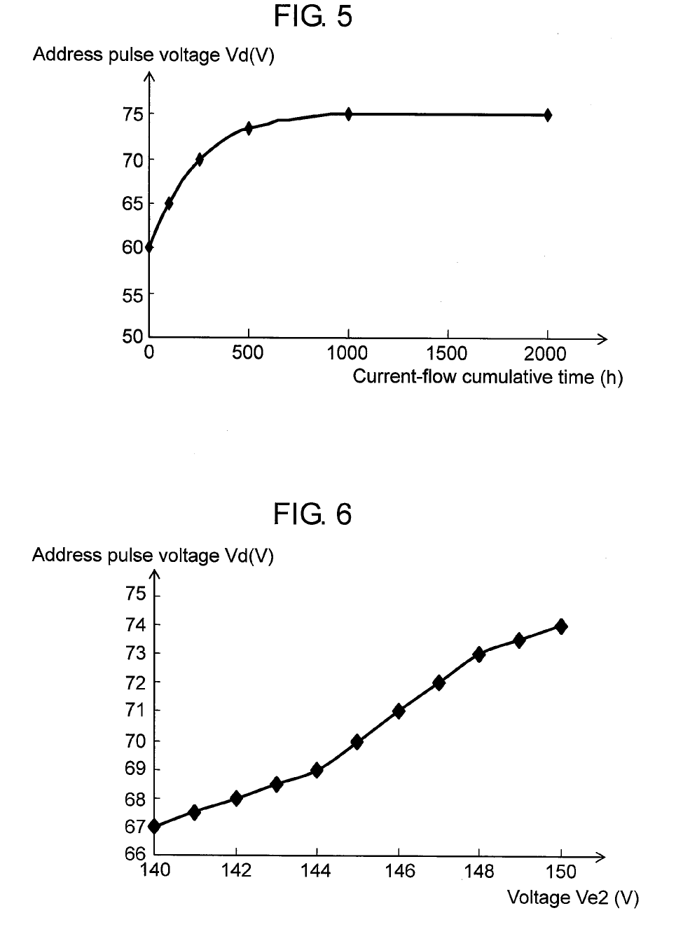

FIG. 5 is a diagram showing an example of a relationship between the current-flow cumulative time of the panel and address pulse voltage Vd required for causing stable address discharge in accordance with the first exemplary embodiment. In FIG. 5, the vertical axis shows address pulse voltage Vd (voltage applied to data electrodes D1 through Dm) required for causing stable address discharge, and the horizontal axis shows the current-flow cumulative time of panel 10.

As shown in FIG. 5, as the current-flow cumulative time of panel 10 increases, address pulse voltage Vd required for causing stable address discharge increases. For example, in the initial state where the current-flow cumulative time is about 0 hour, required address pulse voltage Vd is about 60 (V). When the current-flow cumulative time is about 500 hours, required address pulse voltage Vd is about 73 (V), namely higher than 60 (V) by about 13 (V). After the current-flow cumulative time reaches about 1000 hours, required address pulse voltage Vd is about 75 (V) and hardly varies.

While, in the address period, positive voltage Ve2 is applied to sustain electrodes SU1 through SUn, thereby putting the state between sustain electrode SUi and scan electrode SCi into a state where discharge is apt to occur. The discharge occurring between data electrode Dk and scan electrode SCi causes discharge between sustain electrode SUi and scan electrode SCi in a region crossing data electrode Dk. Therefore, address pulse voltage Vd required for causing the address discharge also varies in response to the value of voltage Ve2. It is recognized that there is a relationship shown below between voltage Ve2 and address pulse voltage Vd required for causing the address discharge.

FIG. 6 is a diagram showing an example of a relationship between voltage Ve2 and address pulse voltage Vd required for causing stable address discharge in accordance with the first exemplary embodiment of the present invention. In FIG. 6, the vertical axis shows address pulse voltage Vd required for causing stable address discharge, and the horizontal axis shows voltage Ve2.

As shown in FIG. 6, address pulse voltage Vd required for causing stable address discharge varies dependently on the value of voltage Ve2. Namely, as voltage Ve2 decrease, address pulse voltage Vd required for causing stable address discharge decreases. For example, when voltage Ve2 is about 150 (V), address pulse voltage Vd required for causing stable address discharge is about 74 (V). When voltage Ve2 is about 140 (V), address pulse voltage Vd is about 67 (V). In other words, voltage Ve2 is decreased from about 150 (V) to about 140 (V), address pulse voltage Vd required for causing stable address discharge decreases by about 7 (V).

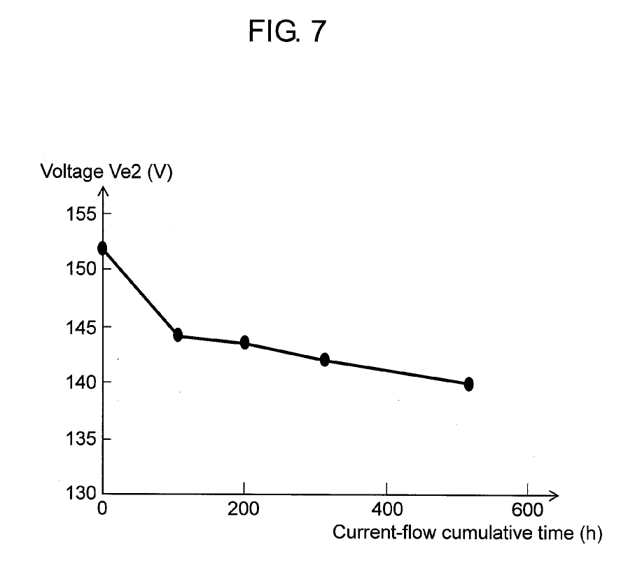

It is recognized that there is the following relationship between the current-flow cumulative time and voltage Ve2 required for causing stable address discharge. FIG. 7 is a diagram showing an example of a relationship between the current-flow cumulative time of panel 10 and voltage Ve2 required for causing stable address discharge in accordance with the first exemplary embodiment of the present invention. In FIG. 7, the vertical axis shows voltage Ve2 required for causing stable address discharge, and the horizontal axis shows the current-flow cumulative time of panel 10.

As shown in FIG. 7, as the current-flow cumulative time of panel 10 increases, voltage Ve2 required for causing stable address discharge decreases. For example, in the initial state where the current-flow cumulative time is about 0 hour, required voltage Ve2 is about 152 (V). When the current-flow cumulative time is about 500 hours, required voltage Ve2 is about 140 (V), namely lower than 152 (V) by about 12 (V).

Thus, since voltage Ve2 required for causing stable address discharge decreases with increase in current-flow cumulative time, it is recognized that voltage Ve2 can be reduced in response to the current-flow cumulative time. Voltage Ve2 is related to address pulse voltage Vd required for causing address discharge, and it is recognized that address pulse voltage Vd required for causing stable address discharge can be decreased.

In other words, varying the value of voltage Ve2 in response to the current-flow cumulative time can compensate the increment of address pulse voltage Vd required for causing address discharge by increase in current-flow cumulative time, and stable address discharge can be caused without increasing required address pulse voltage Vd.

In the present embodiment, the current-flow cumulative time of panel 10 is measured by the cumulative time measuring circuit (described later). When the current-flow cumulative time is the predetermined time or shorter (500 hours or shorter in the present embodiment), voltage Ve2 is set at Ve2H (voltage value derived by adding voltage ΔVe to voltage Ve1 in the present embodiment) as shown in FIG. 4A. After the current-flow cumulative time exceeds the predetermined time (longer than 500 hours in the present embodiment), voltage Ve2 is set at Ve2L (voltage value equal to voltage Ve1 in the present embodiment) lower than Ve2H as shown in FIG. 4B. Thus, when the current-flow cumulative time increases, stable addressing can be achieved without increasing address pulse voltage Vd required for causing stable address discharge.

These experiments are performed using a 50-inch panel where the number of display electrode pairs is 1080. Above-mentioned numerical values are determined based on the panel, and the present embodiment is not limited to these numerical values.

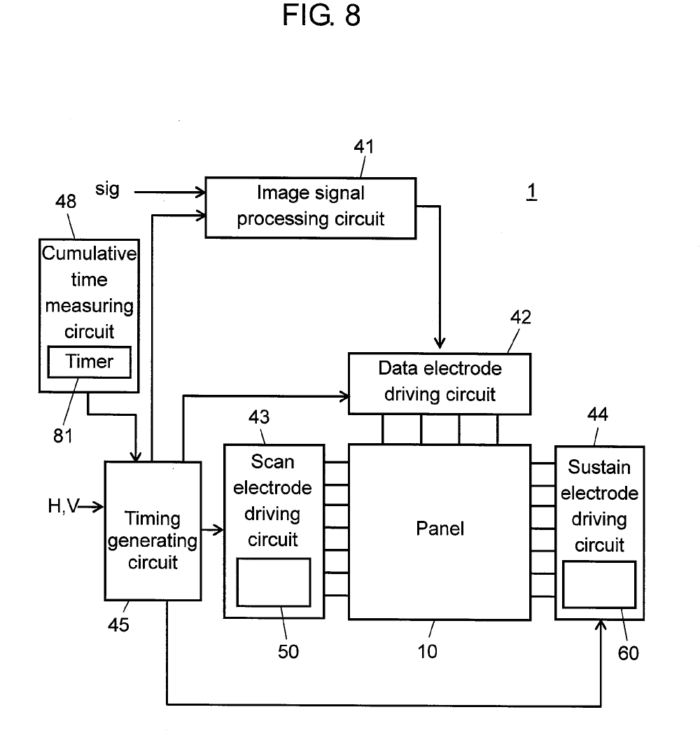

Next, the configuration of the plasma display device of the present embodiment is described. FIG. 8 is a circuit block diagram of the plasma display device of the first exemplary embodiment of the present invention. Plasma display device 1 has the following elements:
panel 10;
image signal processing circuit 41;
data electrode driving circuit 42;
scan electrode driving circuit 43;
sustain electrode driving circuit 44;
timing generating circuit 45;
cumulative time measuring circuit 48; and
a power supply circuit (not shown) for supplying power required for each circuit block.

Image signal processing circuit 41 converts input image signal sig into image data that indicates emission or non-emission of light in each subfield. Data electrode driving circuit 42 converts the image data in each subfield into a signal corresponding to each of data electrodes D1 through Dm, and drives each of data electrodes D1 through Dm.

Cumulative time measuring circuit 48 has a generally known timer 81 having an integrating function of increasing a numerical value by a certain amount every unit time while current is applied to panel 10. In timer 81, the measurement time is accumulated without resetting, and hence the current-flow cumulative time of panel 10 can be measured. Cumulative time measuring circuit 48 compares the current-flow cumulative time of panel 10 measured by timer 81 with a predetermined threshold, determines whether the current-flow cumulative time of panel 10 exceeds the predetermined time, and outputs a signal showing the determination result to timing generating circuit 45.

The threshold is set at 500 hours in the present embodiment; however, the threshold is not limited to this numerical value. Preferably, the threshold is set at an optimal value based on the characteristic of the panel and the specification or the like of the plasma display device.

Timing generating circuit 45 generates various timing signals for controlling an operation of each circuit block based on horizontal synchronizing signal H, vertical synchronizing signal V, and the current-flow cumulative time of panel 10 measured by cumulative time measuring circuit 48, and supplies the signals to respective circuit blocks. In the present embodiment, as discussed above, timing generating circuit 45 controls voltage Ve2 to be applied to sustain electrodes SU1 through SUn in the address period based on the current-flow cumulative time, and outputs a timing signal responsive to this control to sustain electrode driving circuit 44. Thus, control for stabilizing the address operation is performed.

Scan electrode driving circuit 43 has the following elements:
an initializing waveform generating circuit (not shown) for generating an initializing waveform voltage to be applied to scan electrodes SC1 through SCn in the initializing period;
sustain pulse generating circuit 50 for generating sustain pulse voltage to be applied to scan electrodes SC1 through SCn in the sustain period; and
a scan pulse generating circuit (not shown) for generating a scan pulse voltage to be applied to scan electrodes SC1 through SCn in the address period.
   Scan electrode driving circuit 43 drives each of scan electrodes SC1 through SCn based on the timing signal.

Sustain electrode driving circuit 44 has sustain pulse generating circuit 60 and a circuit for generating voltage Ve1 and voltage Ve2, and drives sustain electrodes SU1 through SUn based on the timing signal.

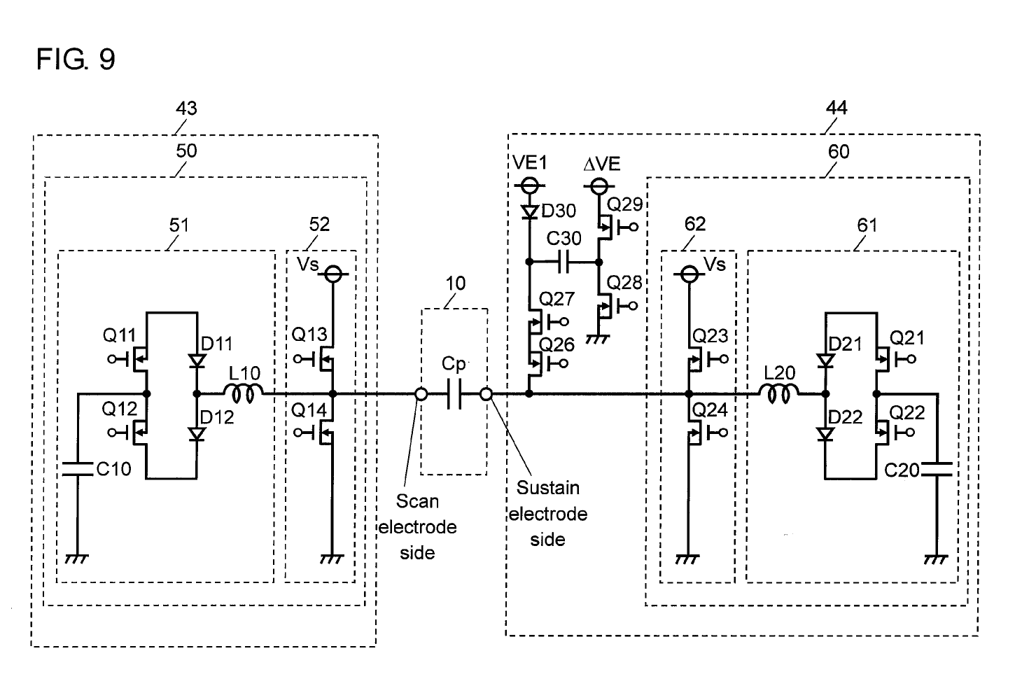

Next, details of sustain pulse generating circuit 50 and sustain pulse generating circuit 60 and their operations are described. Sustain pulse generating circuit 50 is included in scan electrode driving circuit 43, and sustain pulse generating circuit 60 is included in sustain electrode driving circuit 44. FIG. 9 is a circuit diagram of sustain pulse generating circuit 50 and sustain pulse generating circuit 60 in accordance with the first exemplary embodiment of the present invention. In FIG. 9, the inter-electrode capacity of panel 10 is denoted with Cp, and the circuit for generating a scan pulse and the initializing waveform voltage is omitted.

Sustain pulse generating circuit 50 has electric power recovering circuit 51 and clamping circuit 52. Electric power recovering circuit 51 and clamping circuit 52 are connected to scan electrodes SC1 through SCn at one end of inter-electrode capacity Cp of panel 10 through the scan pulse generating circuit (not shown because it becomes into a short circuit state in the sustain period).

Electric power recovering circuit 51 has capacitor C10 for recovering electric power, switching element Q11, switching element Q12, diode D11 and diode D12 for preventing back flow, and inductor L10 for resonance. Inter-electrode capacity Cp and inductor L10 are LC-resonated to raise and fall the sustain pulse. Electric power recovering circuit 51 thus drives scan electrodes SC1 through SCn by LC resonance without receiving electric power from a power supply, so that the power consumption ideally becomes zero. Capacitor C10 for recovering electric power has a capacity sufficiently larger than inter-electrode capacity Cp, and is charged up to about Vs/2, namely a half of voltage value Vs, so as to work as the power supply of electric power recovering circuit 51.

Clamping circuit 52 has switching element Q13 for clamping scan electrodes SC1 through SCn on voltage Vs, and switching element Q14 for clamping scan electrodes SC1 through SCn on 0 (V). Clamping circuit 52 connects scan electrodes SC1 through SCn to power supply VS through switching element Q13 to clamp them on voltage Vs, and grounds scan electrodes SC1 through SCn through switching element Q14 to clamp them on 0 (V). Therefore, the impedance during voltage application by clamping circuit 52 is small, and large discharge current due to strong sustain discharge can be stably applied.

Sustain pulse generating circuit 50 switches switching element Q11, switching element Q12, switching element Q13, and switching element Q14 between conduction and breakage in response to the timing signal supplied from timing generating circuit 45, thereby operating electric power recovering circuit 51 and clamping circuit 52 and generating voltage sustain pulse voltage Vs. Here, the operation of conducting a switching element is denoted with ON, and the operation of breaking it is denoted with OFF in the following description.

For example, in raising a sustain pulse, switching element Q11 is set at ON to resonate inter-electrode capacity Cp and inductor L10, and electric power accumulated in capacitor C10 for recovering electric power is supplied to scan electrodes SC1 through SCn through switching element Q11, diode D11, and inductor L10. When the voltage of scan electrodes SC1 through SCn approaches Vs, switching element Q13 of clamping circuit 52 is set at ON, and scan electrodes SC1 through SCn are clamped on voltage Vs.

While, in falling a sustain pulse waveform, switching element Q12 is set at ON to resonate inter-electrode capacity Cp and inductor L10, and electric power accumulated in inter-electrode capacity Cp is recovered by capacitor C10 for recovering electric power through inductor L10, diode D 12, switching element Q12. When the voltage of scan electrodes SC1 through SCn approaches 0 (V), switching element Q14 of clamping circuit 52 is set at ON, and scan electrodes SC1 through SCn are clamped on voltage 0 (V). Thus, the sustain pulse is applied to scan electrodes SC1 through SCn. These switching elements can be formed of generally known elements such as a metal oxide semiconductor field effect transistor (MOSFET) and an insulated gate bipolar transistor (IGBT).

Sustain pulse generating circuit 60 has electric power recovering circuit 61 and clamping circuit 62. Electric power recovering circuit 61 has capacitor C20 for recovering electric power, switching element Q21, switching element Q22, diode D21 and diode D22 for preventing back flow, and inductor L20 for resonance. Clamping circuit 62 has switching element Q23 for clamping sustain electrodes SU1 through SUn on voltage Vs, and switching element Q24 for clamping sustain electrodes SU1 through SUn on the ground voltage. Sustain pulse generating circuit 60 is connected to sustain electrodes SU1 through SUn at one end of inter-electrode capacity Cp of panel 10. The operation of sustain pulse generating circuit 60 is similar to that of sustain pulse generating circuit 50, and is not described.

FIG. 9 shows power supply VE1 for generating voltage Ve1, switching element Q26 for applying voltage Ve1 to sustain electrodes SU1 through SUn, switching element Q27, power supply AVE for generating voltage ΔVe, diode D30 for preventing back flow, capacitor C30, switching element Q28 for adding voltage ΔVe to voltage Ve1 to generate voltage Ve2, and switching element Q29.

Next, a method of controlling voltage Ve2 using these circuits is described with reference to a drawing. In the drawing, a signal for setting a switching element at ON is denoted with “Hi”, and a signal for setting a switching element at OFF is denoted with “Lo”.

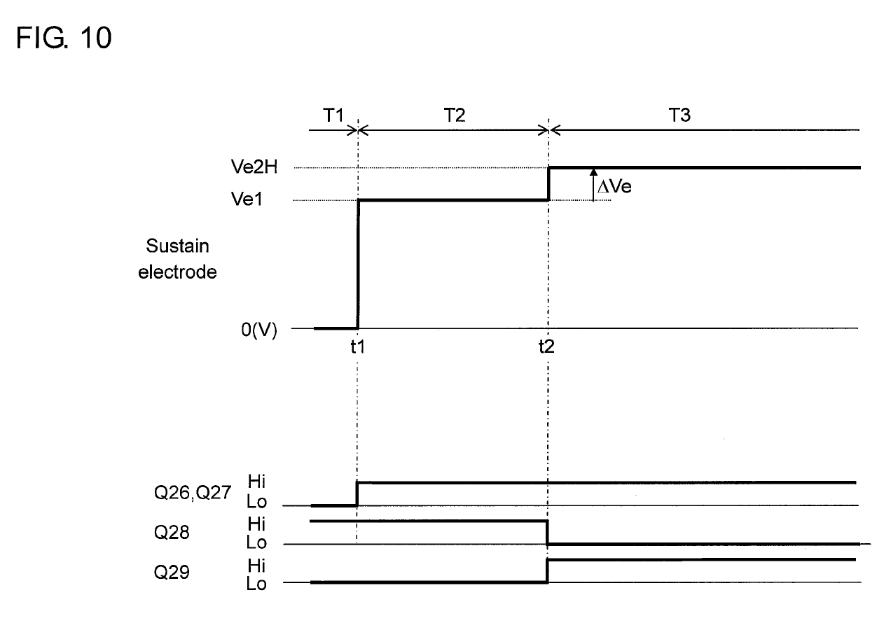

FIG. 10 is a timing chart illustrating an example of generation of voltage Ve1 and voltage Ve2 in accordance with the first exemplary embodiment of the present invention.

(Time Period T1)

In a period when voltage Ve1 or voltage Ve2 is not applied to sustain electrodes SU1 through SUn, for example in the first half of the initializing period of the first SF or in the sustain period as shown in FIG. 3, switching element Q26 and switching element Q27 are firstly set at OFF to electrically separate sustain electrodes SU1 through SUn from power supply VE1 so as to prevent voltage Ve1 from being applied to sustain electrodes SU1 through SUn. Thus, a state is obtained where sustain electrodes SU1 through SUn can be driven by sustain pulse generating circuit 60. For example, only switching element Q24 of sustain pulse generating circuit 60 is set at ON and the other switching elements are set at OFF, sustain electrodes SU1 through SUn can be grounded. As shown in FIG. 9, when each switching element of sustain pulse generating circuit 60 is controlled, a sustain pulse can be applied to sustain electrodes SU1 through SUn. At this time, switching element Q29 is previously set at OFF, switching element Q28 is previously set at ON, and one side of capacitor C30 is previously grounded.

(Time Period T2)

Next, in a Period when Voltage Ve1 is Applied to Sustain Electrodes SU1 through SUn, for example in the last half of the initializing period of the first SF or in the initializing period of the second SF as shown in FIG. 3, switching element Q26 and switching element Q27 are set at ON. Thus, sustain electrodes SU1 through SUn are electrically connected to power supply VE1, and positive voltage Ve1 is applied to sustain electrodes SU1 through SUn through diode D30, switching element Q26, and switching element Q27. At this time, switching element Q29 is kept at OFF, switching element Q28 is kept at ON, and one side of capacitor C30 is kept to be grounded. Thus, capacitor C30 is charged by power supply VE1 so that the voltage of capacitor C30 becomes voltage Ve1. All switching elements of sustain pulse generating circuit 60 are previously set at OFF.

(Time Period T3)

Next, in the address period shown in FIG. 4A, namely in a period when voltage Ve2H is applied to sustain electrodes SU1 through SUn, switching element Q28 is set at OFF and switching element Q29 is set at ON while switching element Q26 and switching element Q27 are kept at ON, thereby switching one side of capacitor C30 from the grounded state to the connection state to power supply ΔVE. Thus, voltage ΔVe is applied to one side of capacitor C30 to add voltage ΔVe to the voltage of capacitor C30. Thus, voltage Ve1+ΔVe, namely voltage Ve2H, can be applied to sustain electrodes SU1 through SUn. The current from capacitor C30 to voltage VE1 is broken by diode D30 for preventing back flow.

Next, in the address period shown in FIG. 4B, namely in a period when voltage Ve2L is applied to sustain electrodes SU1 through SUn, each switching element is kept in a state similar to that in time period T2. Thus, voltage Ve1, namely voltage Ve2L, can be applied to sustain electrodes SU1 through SUn.

Thus, in the present embodiment, when the circuit for generating voltage Ve1 and voltage Ve2H of sustain electrode driving circuit 44 has circuitry as shown in FIG. 9, the value of voltage Ve2 applied to sustain electrodes SU1 through SUn in the address period can be switched between voltage Ve1 (or voltage Ve2L) and voltage Ve2H.

The circuit for applying voltage Ve1 and voltage Ve2H shown in FIG. 9 is just one example. For changing voltage Ve2, various methods other than the above-mentioned method can be used. For example, the circuit is configured using a power supply for generating voltage Ve1, a power supply for generating voltage Ve2H, and a plurality of switching elements for independently applying each power supply voltage to sustain electrodes SU1 through SUn. Each voltage is applied to sustain electrodes SU1 through SUn with a required timing. The present embodiment is not limited to the above-mentioned circuitry, but may be the other method or circuitry.

In the present embodiment, voltage Ve1 is set at 140 (V) and ΔVe is set at 10 (V), thereby making voltage Ve2H higher than voltage Ve2L by 10 (V). However, these voltages are not limited to these voltage values, but are preferably set at optimal values in response to the characteristic of the panel and the specification or the like of the plasma display device.

In the present embodiment, as discussed above, the value of voltage Ve2 applied to sustain electrodes SU1 through SUn in the address period is switched between voltage Ve2H and voltage Ve2L lower than voltage Ve2H, and the value of voltage Ve2 is varied in response to the current-flow cumulative time to panel 10. In other words, when the current-flow cumulative time to panel 10 measured by cumulative time measuring circuit 48 is a predetermined time or shorter (500 hours or shorter in the present embodiment), voltage Ve2 is set at Ve2H and is applied to sustain electrodes SU1 through SUn. After the current-flow cumulative time exceeds the predetermined time (longer than 500 hours in the present embodiment), voltage Ve2 is set at Ve2L (equal to Ve1 in the present embodiment) lower than Ve2H, and is applied to sustain electrodes SU1 through SUn. Thus, when the current-flow cumulative time increases, stable addressing can be achieved without increasing address pulse voltage Vd required for causing stable address discharge.

In the present embodiment, as discussed above, when the current-flow cumulative time is the predetermined time or shorter, voltage Ve2 is set at Ve2H in the address period of all subfields as shown in FIG. 4A. After the current-flow cumulative time exceeds the predetermined time, voltage Ve2 is set at Ve2L in the address period of all subfields as shown in FIG. 4B. However, the present invention is not limited to this configuration, but may have the other subfield configuration.

For example, the present invention may have a configuration having a subfield where voltage Ve2 is set at Ve2L when the current-flow cumulative time is the predetermined time or shorter. The present invention may have a configuration having a subfield where voltage Ve2 is set at Ve2H after the current-flow cumulative time exceeds the predetermined time. In the present invention, the percentage, in one field, of the subfield where voltage Ve2 is set at Ve2L after the current-flow cumulative time exceeds the predetermined time is made larger than that when the current-flow cumulative time is the predetermined time or shorter. This configuration can provide an advantage similar to the above-mentioned configuration.

In the present embodiment, as discussed above, voltage ΔVe is set at 10 (V), voltage Ve2L is set at a voltage value equal to voltage Ve1, and voltage Ve2 is switched between voltage Ve2L, namely voltage Ve1, and voltage Ve2H higher than voltage Ve2L by 10 (V). However, voltage Ve2L is not required to be equal to voltage Ve1, but voltage Ve2L may be higher than voltage Ve1, or voltage Ve2L may be lower than voltage Ve1. Voltage Ve2L is required to be set lower than Ve2H. The potential difference between Ve2L and Ve2H, the value of voltage Ve1, or the like are not limited to the above-mentioned values, but are preferably set at optimal values in response to the characteristic of the panel and the specification or the like of the plasma display device.

In the present embodiment, the value of voltage Ve2 is switched between two voltage values of Ve2L and Ve2H. However, the present invention is not limited to this configuration, but the value of voltage Ve2 may be switched between three or more voltage values.

### Second Exemplary Embodiment

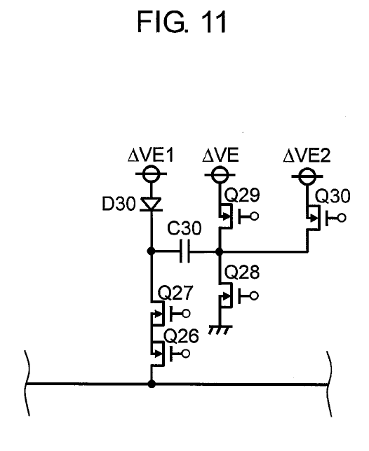

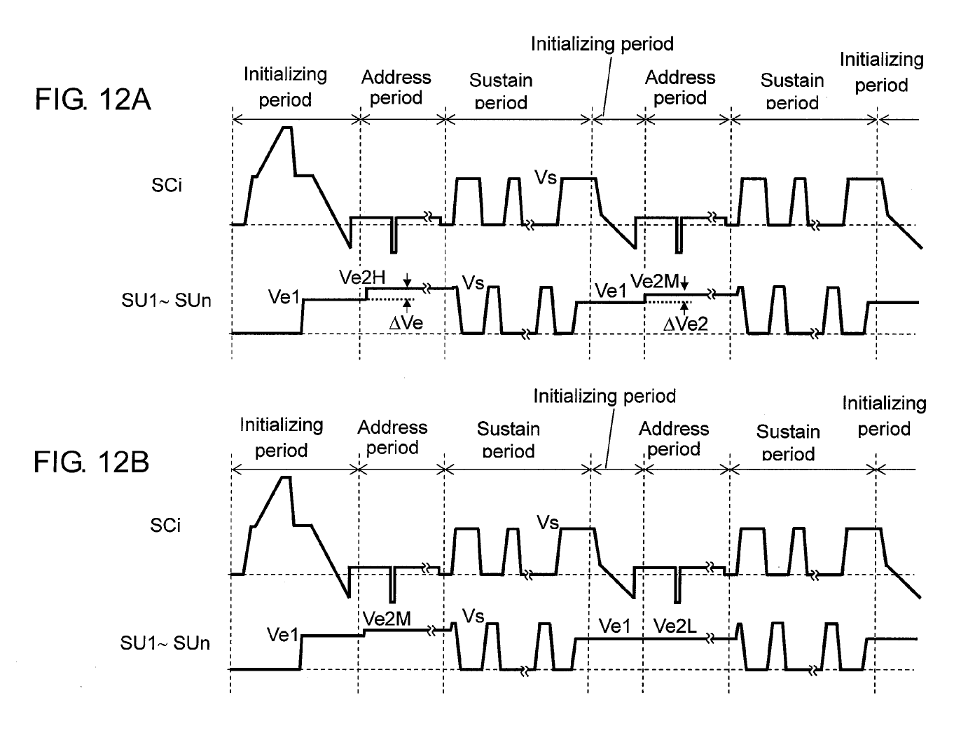

FIG. 11 is a circuit diagram showing an example of a configuration where the value of voltage Ve2 is generated by switching in accordance with the second exemplary embodiment of the present invention. FIG. 12 is a chart showing an example of a subfield configuration in accordance with the second exemplary embodiment. The second embodiment differs from the first embodiment partially in the configuration of the circuit for generating the value of voltage Ve2 by switching. The configurations, operations, driving waveforms of the other circuits in the second embodiment are the same as those in the first embodiment.

For example, as shown in FIG. 11, the following configuration may be used. Power supply ΔVE2 for generating voltage ΔVe2 and switching element Q30 for connecting power supply ΔVE2 to capacitor C30 are added to the circuit for generating voltage Ve1 and voltage Ve2 shown in FIG. 9, and voltage Ve2M whose value is between Ve2H and Ve2L is generated. Here, as an example, Ve2H is set higher than Ve2L by 10 (V), and Ve2M is set higher than Ve2L by 5 (V). In the circuitry shown in FIG. 11, Ve2M can be applied to sustain electrodes SU1 through SUn instead of Ve2H by setting switching element Q30 at ON instead of switching element Q29.

The present embodiment may have a configuration including a subfield where voltage Ve2 is set at Ve2M when the current-flow cumulative time is the predetermined time or shorter. For example, as shown by an example of FIG. 12A, voltage Ve2 may be set at Ve2H in the address period of the first SF, and may be set at Ve2M in the address period of the second SF through 10th SF.

The present embodiment may have a configuration including a subfield where voltage Ve2 is set at Ve2M after the current-flow cumulative time exceeds the predetermined time. For example, as shown by an example of FIG. 12B, voltage Ve2 may be set at Ve2L in the address period of the second SF through ninth SF, and may be set at Ve2M in the address period of the first SF. In the present invention, the percentage, in one field, of the subfield where voltage Ve2 is set at the lowest voltage value (Ve2L here) after the current-flow cumulative time exceeds the predetermined time must be made larger than that when the current-flow cumulative time is the predetermined time or shorter. This configuration can provide an advantage similar to the above-mentioned configuration.

In the present embodiment, the predetermined time is set at 500 hours, and the value of voltage Ve2 is varied according to whether the current-flow cumulative time is 500 hours or shorter or exceeds 500 hours. However, the present invention is not limited to this value, but is preferably set at an optimal value in response to the characteristic of the panel and the specification or the like of the plasma display device. The following configuration may be used. A plurality of thresholds such as 500 hours, 750 hours, and 1000 hours are set, and the percentage, in one field, of the subfield where voltage Ve2 is set at Ve2L is gradually increased whenever the current-flow cumulative time exceeds each threshold.

In the present embodiment, as discussed above, the value of voltage Ve2 is varied after the current-flow cumulative time exceeds the predetermined time. However, the following configuration may be used. After the current-flow cumulative time exceeds the predetermined time and until the plasma display device temporarily comes into a non-operation state, driving by the same driving waveform as before is continued, and the value of voltage Ve2 is varied with the timing of the next operation start. For example, even when a signal showing that the current-flow cumulative time exceeds the predetermined time is supplied from cumulative time measuring circuit 48 in an operation state of plasma display device 1, timing generating circuit 45 outputs each timing signal for driving panel 10 as the same timing signal as before. Here, the operation state of plasma display device 1 means the state where timing generating circuit 45 is in the operation state and outputs each timing signal for driving panel 10. Next, when the plasma display device is temporarily powered off, and then is powered on to start the driving of panel 10, timing generating circuit 45 may output a timing signal for setting voltage V12 at Ve2L. This configuration can prevent fluctuation in brightness that can be generated by variation of the driving voltage during addressing in the operation of plasma display device 1, and also can increase the image display quality.

In the present embodiment, the voltage value of Ve2L, the voltage value of Ve2H, a subfield for switching voltage Ve2, and subfield configuration are not limited to the above-mentioned values, but are preferably set at optimal values in response to the characteristic of the panel and the specification or the like of the plasma display device.

In the embodiment of the present invention, the xenon partial pressure of discharge gas is set at 10%. However, even when the xenon partial pressure is set at another value, the driving voltage is set at a value corresponding to the panel.

The other specific values used in the embodiment of the present invention are just one example, and are preferably set at optimal values in response to the characteristic of the panel and the specification or the like of the plasma display device.

### INDUSTRIAL APPLICABILITY

In the present invention, the value of the second voltage applied to the sustain electrode in the address period even in a panel of high luminance is varied in response to the cumulative time when current is applied to the panel. Therefore, when the current-flow cumulative time to the panel is increased, stable address discharge can be caused without increasing the voltage required for causing the address discharge. The present invention is useful as a plasma display device of high image display quality and a driving method of the panel.

1. A plasma display device comprising:
a plasma display panel having a plurality of discharge cells, each of the discharge cells having a display electrode pair that includes a scan electrode and a sustain electrode;
a cumulative time measuring circuit for measuring cumulative time when current is applied to the plasma display panel; and
wherein a plurality of subfields are set in one field, the subfields having:
an initializing period for initializing the discharge cell;
an address period for selecting the discharge cell to be discharged;
a sustain period for causing sustain discharge in the discharge cell selected in the address period; and
a sustain electrode driving circuit for driving the sustain electrode by applying a first voltage to the sustain electrode in the initializing period and applying a second voltage to the sustain electrode in the address period,
wherein the sustain electrode driving circuit varies a voltage value of the second voltage in response to the cumulative time measured by the cumulative time measuring circuit.

2. The plasma display device of claim 1, wherein
the sustain electrode driving circuit increases a percentage of a subfield, where the second voltage is set at a lowest voltage value in response to the cumulative time, in one field.

3. The plasma display device of claim 1, wherein
the sustain electrode driving circuit sets the second voltage to the lowest voltage value in response to the cumulative time in the address period of all subfields.

4. The plasma display device of claim 1, wherein
in varying a voltage value of the second voltage in response to the cumulative time, the sustain electrode driving circuit continues driving by a driving waveform similar to before until the plasma display device comes into a non-operation state, and varies the voltage value of the second voltage after the plasma display device comes into an operation state.

5. The plasma display device of claim 1, wherein
the sustain electrode driving circuit sets the second voltage to a voltage value higher than the first voltage before the cumulative time exceeds a predetermined time, and sets the second voltage to a voltage value equal to the first voltage after the cumulative time exceeds the predetermined time.

6. A driving method of a plasma display panel having a plurality of discharge cells, each of the discharge cells having a display electrode pair that includes a scan electrode and a sustain electrode,
wherein a plurality of subfields are set in one field, the subfields having:
an initializing period for initializing the discharge cell;
an address period for selecting the discharge cell to be discharged; and
a sustain period for causing sustain discharge in the discharge cell selected in the address period,
the method comprising:
driving the sustain electrode by applying a first voltage to the sustain electrode in the initializing period and applying a second voltage to the sustain electrode in the address period;
measuring cumulative time when current is applied to the plasma display panel; and
varying a voltage value of the second voltage in response to the measured cumulative time.
